(19) United States
(12) Patent Application Publication
(10) Pub. No.: US 2020/0127521 A1
(43) Pub. Date: Apr. 23, 2020

(54) ELECTRIC WIRE AND STATOR

(71) Applicant: HONDA MOTOR CO., LTD., Tokyo (JP)

(72) Inventors: Keisuke Azusawa, Wako-shi (JP); Ryotaro Kaneko, Wako-shi (JP); Tadao Nishiyama, Wako-shi (JP)

(21) Appl. No.: 16/598,070

(22) Filed: Oct. 10, 2019

(30) Foreign Application Priority Data
Oct. 18, 2018 (JP) 2018-196994

(51) Int. Cl. H02K 3/40; H02K 3/30

(52) U.S. Cl. CPC H02K 3/40; H02K 3/30

(57) ABSTRACT

An electric wire includes a conductor, and an insulating film that is configured to cover the conductor and that includes a porous layer having porous in an insulating material, and a non-porous layer formed with the insulating material while having no porous therein.

### CROSS-REFERENCE TO RELATED APPLICATION

Priority is claimed on Japanese Patent Application No. 2018-196994, filed Oct. 18, 2018, the content of which is incorporated herein by reference.

### BACKGROUND OF THE INVENTION

### Field of the Invention

The present invention relates to an electric wire and a stator.

### Description of Related Art

In the related art, as a stator for a rotating electric machine, a configuration including a coil mounted on a stator core by inserting a conductor segment into slots formed in the stator core and joining conductor end portions protruding from the stator core is known. Regarding an electric wire used in such a coil, a plurality of fine porous are contained in an insulating film, and various technologies for improving the insulation properties of an insulating film have been proposed.

For example, as shown in FIG. 7, PCT International Publication No. 2017/073551 discloses a structure of an electric wire 200 having a plurality of pores (porous) 220 formed in an insulating film 201 configured to cover an outer circumference of a conductor 202. The porous 220 are formed by heating the insulating film 201 including a pyrolytic resin and an outer shell member 230 that surrounds the pyrolytic resin to a temperature at which the pyrolytic resin is gasified. When the porous 220 having a capsule shape surrounded by the outer shell member 230 are formed in this way, the insulating film 201 having a low dielectric constant can be realized, and insulation properties of the insulating film 201 with respect to a high voltage can be improved.

Japanese Unexamined Patent Application, First Publication No. 2016-81563 discloses a configuration in which porous are formed in a heat fusion layer disposed as the outermost surface of an electric wire. According to the technology disclosed in Japanese Unexamined Patent Application, First Publication No. 2016-81563, the porous are generated when a plurality of electric wires are bound to form a coil, and the heat fusion layer can be expanded due to occurrence of the porous and neighboring electric wires can be easily melted while improving the insulation properties of the electric wire.

### SUMMARY OF THE INVENTION

In this way, while introduction of porous is effective in order to improve insulation properties of an insulating film, when a plurality of porous merge and large cavities are formed, strength and insulation properties of the insulating film may be decreased conversely. For this reason, in the technologies disclosed in PCT

International Publication No. 2017/073551 and Japanese Unexamined Patent Application, First Publication No. 2016-81563, a configuration in which the outer shell member that surrounds the porous is provided to prevent a plurality of porous from merging with each other is provided. However, since the outer shell members are formed of a special material different from the insulating material, material costs, manufacturing costs, or the like, may be increased.

Accordingly, there is room for improvement in terms of providing an electric wire in which insulation properties of an insulating film are improved using an inexpensive and simple configuration, and a stator including the same.

An aspect of the present invention is directed to providing an electric wire in which insulation properties of an insulating film are improved using an inexpensive and simple configuration, and a stator including the same.

(1) An electric wire according to the present invention includes a conductor; and an insulating film that is configured to cover the conductor and that includes a porous layer having porous in an insulating material, and a non-porous layer formed with the insulating material while having no porous therein.

(2) In the aspect of the above-mentioned (1), the insulating film may be formed of a plurality of three or more layers by alternately disposing the porous layers and the non-porous layers in a radial direction of the conductor.

(3) In the aspect of the above-mentioned (1) or (2), a thickness of the single porous layer may be 20 μm or less.

(4) A stator according to an aspect of the present invention includes the electric wire according to any one of the above-mentioned (1) to (3).

According to the aspect of the above-mentioned (1), since the insulating film has the porous layer, a dielectric constant of the insulating film can be decreased due to formation of the porous, and insulation properties of the insulating film can be improved. Meanwhile, since the non-porous layer has no porous therein, a strength of the insulating film can be improved in comparison with the porous layer. In this way, since the insulating film includes the porous layer and the non-porous layer, it is possible to provide an electric wire in which a strength of an insulating film is improved due to a non-porous layer while insulation properties of the insulating film are improved due to the porous layer. In addition, in comparison with a case in which the insulating film has only the porous layer, since the porous layers are separated by the non-porous layers and a volume per unit of the porous layers is reduced, a decrease in insulation properties due to merging of porous in the porous layer and formation of large cavities can be suppressed. Accordingly, there is no need to provide the outer shell member for making the porous independent individually, and material costs can be reduced while facilitating formation of the porous layer.

Accordingly, it is possible to provide the electric wire in which insulation properties of the insulating film are improved by an inexpensive and simple configuration.

According to the aspect of the above-mentioned (2), since the porous layer and the non-porous layer are alternately disposed in the radial direction, both of improvement in insulation properties and an increase in strength of the insulating film can be achieved. In addition, since the non-porous layer is disposed between the porous layers in the radial direction, formation of a large cavity due to coupling of the porous in the radial direction can be suppressed. Accordingly, independence of the porous in the porous layer can be guaranteed by the non-porous layer. Accordingly, it is possible to provide the electric wire in which insulation properties of the insulating film are improved by an inexpensive and simple configuration.

According to the aspect of the above-mentioned (3), since the thickness of one layer of the porous layer is 20 μm or less, even if the porous in the porous layer are coupled, a size of the cavity is 20 μm or less.

Here, in an atmospheric environment, regarding a voltage at which discharge starts to occur between parallel plate electrodes, the voltage is a minimum value when an inter-electrode distance is about 22 μm. When the inter-electrode distance is 22 μm or less, since initiating electrons present (in a gap) between the electrodes cannot be sufficiently accelerated because a distance at which the initial electron is accelerated is short, discharge cannot easily occur. Meanwhile, when the inter-electrode distance is 22 μm or more, while discharge cannot easily occur because the initial electron cannot be accelerated due to an electric field strength between the electrodes be insufficient, discharge may occur due to an increase in voltage between the electrodes.

Here, in the electric wire of the aspect of the present invention, the thickness of one layer of the porous layer is made to 20 μm or less, and the size of a gap is made to 20 μm or less. Accordingly, even when the cavity is formed, the size of the cavity can be set to a range in which discharge cannot easily occur. Accordingly, it is possible to provide the electric wire having the insulating film in which occurrence of partial discharge is inhibited and insulation properties are excellent.

In addition, since the insulation properties are secured even when the porous are coupled to form the cavity, there is no need to cover each of the porous with the outer shell member. Accordingly, there is no need to provide the outer shell member, and material costs or manufacturing costs can be reduced.

According to the aspect of the above-mentioned (4), it is possible to provide an inexpensive and high performance stator because the electric wire in which insulation properties of the insulating film are improved by an inexpensive and simple configuration is provided.

### BRIEF DESCRIPTION OF THE DRAWINGS

FIG. 1 is a perspective view of an appearance of a stator according to a first embodiment.

FIG. 2 is a cross-sectional view of the electric wire according to the first embodiment.

FIG. 3 is a cross-sectional view taken along line in FIG. 2.

FIG. 4 is a view for describing a method of manufacturing an electric wire according to the first embodiment.

FIG. 5 is a graph showing a relation between an inter-electrode distance between parallel plate electrodes and a discharge starting voltage.

FIG. 6 is a cross-sectional view of an electric wire according to a second embodiment.

FIG. 7 is a cross-sectional view of an electric wire in the related art.

### DETAILED DESCRIPTION OF THE INVENTION

Hereinafter, embodiments of the present invention will be described with reference to the accompanying drawings.

### First Embodiment

### (Stator)

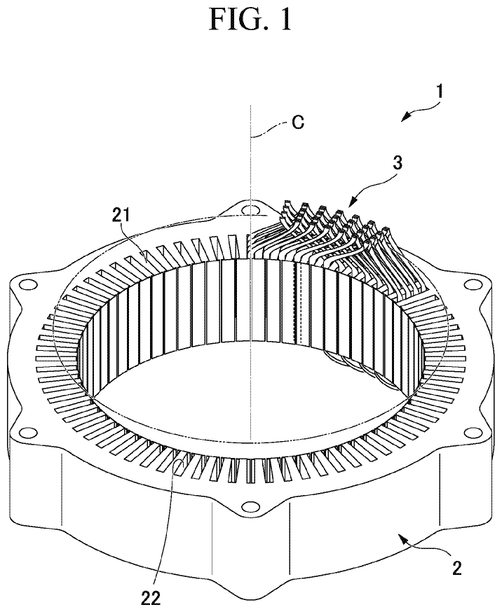

FIG. 1 is a perspective view of appearance of a stator 1. The stator 1 includes a stator core 2 and a coil 3. Further, in FIG. 1, a part of the coil 3 is omitted for the convenience of description.

The stator core 2 is formed in an annular shape about an axis C. Teeth 21 are formed on an inner circumferential surface of the stator core 2. The teeth 21 protrude inward from the inner circumferential surface of the stator core 2 in a radial direction. A plurality of teeth 21 are formed in a circumferential direction.

Slots 22 are formed between the teeth 21, and the coil 3, which will be described below, is inserted into the slots 22. A rotor (not shown) is rotatably disposed about the axis C in the stator core 2.

In the following description, a direction along the axis C of the stator core 2 may be referred to as an axial direction, a direction perpendicular to the axis C may be referred to as a radial direction, and a direction around the axis C may be referred to as a circumferential direction.

The coil 3 is inserted into the slots 22 of the stator core 2 and mounted on the stator core 2. The coil 3 is constituted by a plurality of electric wires 10. Specifically, the coil 3 is inserted into the slots 22 from one side in the axial direction (a side below in FIG. 1) in a state in which the plurality of electric wires 10 curved in a U shape are overlapped in the radial direction and the circumferential direction. After that, end portions of the electric wires 10 protruding from the slots 22 toward the other side in the axial direction (a side above in FIG. 1) are joined to each other, and the coil 3 is mounted on the stator core 2. A portion of the coil 3 inserted into the slots 22 is a coil insertion section 31, and portions protruding from an end surface of the stator core 2 toward one side and the other side in the axial direction are coil ends 32.

### (Electric Wire)

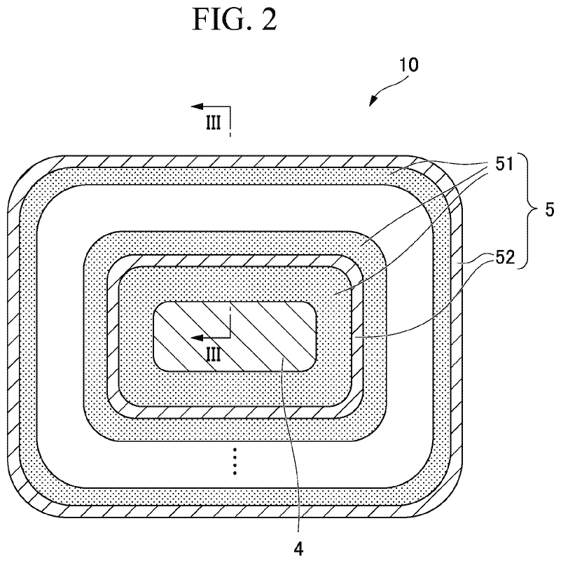

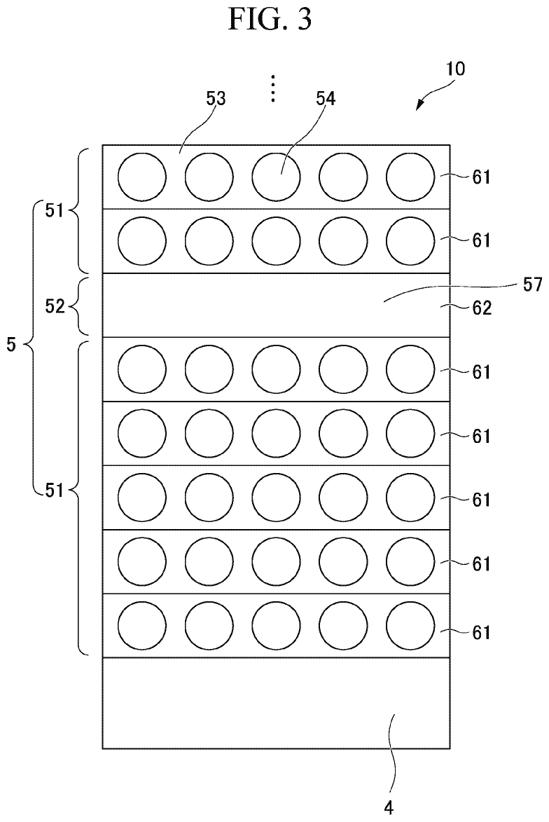

FIG. 2 is a cross-sectional view of an electric wire 10. FIG. 3 is a cross-sectional view taken along line in FIG. 2. The electric wire 10 has a conductor 4 and an insulating film 5.

The conductor 4 constitutes a core portion of the coil 3, and is formed of, for example, a metal material such as copper or the like.

The conductor 4 is formed in a linear shape having a rectangular cross section. The coil end 32 disposed at the other side of the stator core 2 in the axial direction has the conductor 4, a part of which is exposed, and neighboring conductors 4 are electrically and physically joined to each other (see FIG. 1).

The insulating film 5 covers an outer circumferential section of the conductor 4. The insulating film 5 is formed of, for example, an insulating resin. The insulating film 5 is formed throughout the length of the conductor 4 except the exposed section of the conductor 4 in the coil end 32 disposed at the other side in the axial direction. The insulating film 5 has a porous layer 51 and a non-porous layer 52. The insulating films 5 are formed to provide a plurality of layers of three layers or more by alternately disposing the porous layers 51 and the non-porous layers 52 in the radial direction of the conductor 4.

As shown in FIG. 3, the porous layer 51 has, for example, a plurality of porous layer forming films 61. The porous layer forming film 61 is a portion formed through single baking in a manufacturing process of repeating applying and baking of a varnish that is a base material of an insulating material 53 to form the insulating film 5. Further, the manufacturing process of the insulating film 5 will be described below in detail. A thickness of the porous layer forming film 61 is about 3 to 4 μm. In the embodiment, the porous layer 51 has five layers of the porous layer forming films 61. A thickness of a single layer of the porous layer 51 is set to 20 μm or less.

The porous layer forming film 61 has the insulating material 53 in which porous 54 are formed. In other words, the porous layer forming film 61 (the porous layer 51) has the porous 54 therein. The insulating material 53 is formed of, for example, an insulating resin such as a polyimide or the like. The porous 54 are formed in the insulating material 53 by heating the pyrolytic resin contained in the insulating material 53 and gasifying the pyrolytic resin.

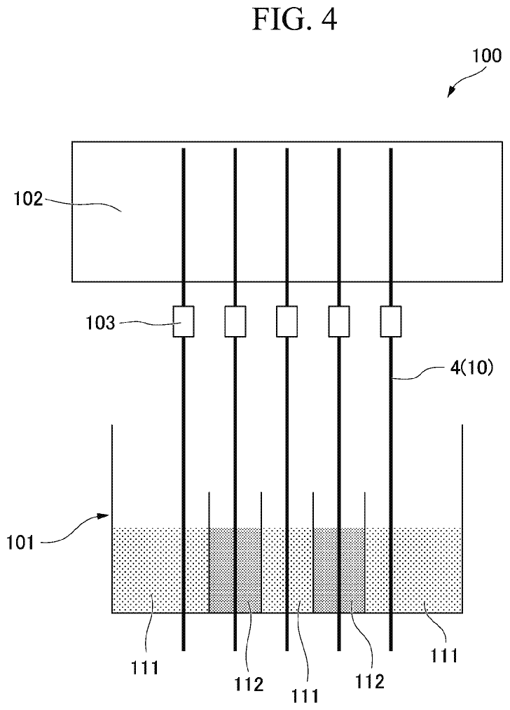

The non-porous layer 52 has, for example, one or a plurality of non-porous layer forming films 62. The non-porous layer forming film 62 is formed through the same method as the above-mentioned porous layer forming film 61 by performing applying and baking of a normal varnish 112 (see FIG. 4) in which a pyrolytic resin for forming the porous 54 is not contained. In the embodiment, the non-porous layer 52 has a single non-porous layer forming film 62. The non-porous layer 52 is disposed as the outermost surface of the electric wire 10.

The non-porous layer forming film 62 has an insulating material 57 formed with no porous 54 therein. The insulating material 57 is formed of, for example, an insulating resin such as polyimide or the like. In the embodiment, the insulating material 53 of the porous layer 51 and the insulating material 57 of the non-porous layer 52 are the same material. Further, the insulating material 53 of the porous layer forming film 61 and the insulating material 57 of the non-porous layer forming film 62 may be different materials.

Here, provided that a dielectric constant of the insulating materials 53 and 57 is α, a dielectric constant of the insulating film 5 (the porous layer 51) having the porous 54 therein is β, and a dielectric constant of air (the porous 54) is γ, α>β>γ. Accordingly, the dielectric constant β of the porous layer 51 having the porous 54 therein is smaller than the dielectric constant α of the non-porous layer 52 formed with no porous 54 therein. In this way, an electrical resistance of the entire insulating film 5 is improved by providing the porous layer 51.

The electric wire 10 is formed by alternately disposing the porous layers 51 and the non-porous layers 52 in the radial direction of the conductor 4 in the outer circumferential section of the conductor 4.

### (Apparatus for Manufacturing Insulating Film)

FIG. 4 is a view for describing an apparatus 100 for manufacturing the insulating film 5. The manufacturing apparatus 100 includes a varnish tank 101, a baking furnace 102 and a die 103.

The varnish tank 101 has a porous binder varnish 111 including a pyrolytic resin and the normal varnish 112 containing no pyrolytic resin. The porous binder varnish 111 forms the porous layer forming film 61 in which the porous 54 are formed when the porous binder varnish 111 is heated and the pyrolytic resin therein is gasified. That is, the porous binder varnish 111 forms the porous layer 51 after this. The normal varnish 112 forms the non-porous layer forming film 62 having no porous 54 therein. That is, the normal varnish 112 forms the non-porous layer 52 later on.

The baking furnace 102 fixes the normal varnish 112 and the porous binder varnish 111 (hereinafter, simply referred to as a varnish) applied to the conductor 4 to the conductor 4 through baking.

The die 103 movably holds the electric wire 10 in the axial direction of the electric wire 10.

### (Process of Manufacturing Insulating Film)

A process of manufacturing the insulating film 5 using the manufacturing apparatus 100 will be described. The process of manufacturing the insulating film 5 has an applying process of applying the varnishes 111 and 112 (the insulating materials 53 and 57 later on) to the outer circumferential section of the conductor 4, and a baking process of fixing the varnishes 111 and 112 through baking. The insulating film 5 is formed by repeating the applying process and the baking process a predetermined number of times.

Specifically, for example, the porous layer forming film 61 of a single layer is formed by performing the baking process of baking the porous binder varnish 111 in the baking furnace 102 after the applying process of applying the porous binder varnish 111 to the conductor 4. Similarly, the non-porous layer forming film 62 of a single layer is formed by performing the baking process of baking the normal varnish 112 in the baking furnace 102 after the applying process of applying the normal varnish 112 to the conductor 4. In the embodiment, first, after applying the porous binder varnish 111 to the conductor 4, the porous layer forming film 61 is formed through baking, and the applying process and the baking process of the porous binder varnish 111 are repeated five times. Accordingly, the porous layer 51 having five layers of porous layer forming films 61 is formed. Next, the non-porous layer forming film 62 of one layer is formed through baking after applying the normal varnish 112 to the outer circumferential section of the porous layer 51. Next, the porous layer forming film 61 is formed through baking after applying the porous binder varnish 111 to the outer circumferential section of the non-porous layer 52 again.

When the above-mentioned processes are repeated until the insulating film 5 has a predetermined thickness, the insulating film 5 in which the porous layer 51 having the porous layer forming films 61 of five layers and the non-porous layer 52 having the non-porous layer forming film 62 of one layer are alternately disposed is manufactured.

### (Actions and Effects)

Next, actions and effects of the electric wire 10 and the stator 1 will be described.

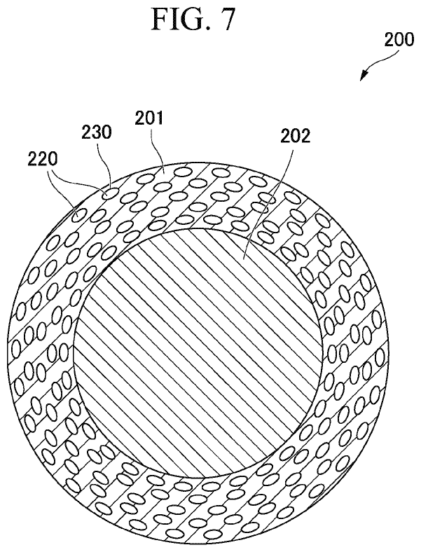

Here, as shown in FIG. 7, in the conventional configuration in which an insulating film 201 has a porous layer only, strength and insulation properties of the insulating film 201 may be decreased conversely when large cavities obtained by coupling a plurality of porous 220 are formed. For this reason, in the related art, there is a need to provide the outer shell member 230 that surrounds the porous 220 to prevent the plurality of porous 220 from being coupled, and costs such as material costs, manufacturing costs, or the like, of the outer shell member 230 may be increased.

According to the electric wire 10 of the embodiment, since the insulating film 5 has the porous layer 51, a dielectric constant of the insulating film 5 can be decreased by forming the porous 54, and insulation properties of the insulating film 5 can be improved. Meanwhile, since the non-porous layer 52 has no porous 54 therein, strength of the insulating film 5 can be improved in comparison with the porous layer 51. In this way, since the insulating film 5 includes the porous layer 51 and the non-porous layer 52, it is possible to provide the electric wire 10 in which strength of the insulating film 5 is improved due to the non-porous layer 52 while insulation properties of the insulating film 5 are improved due to the porous layer 51. In addition, in comparison with the case in which the insulating film 5 has the porous layer 51 only, a volume per a unit porous layer 51 obtained by dividing the porous layer 51 using the non-porous layer 52 is decreased. Accordingly, a decrease in insulation properties due to formation of large cavities obtained by coupling the porous 54 in the porous layer 51 can be suppressed. Accordingly, the outer shell member configured to make the porous 54 independent individually becomes unnecessary, and material costs can be reduced while facilitating formation of the porous layer 51.

Accordingly, it is possible to provide the electric wire 10 in which the insulation properties of the insulating film 5 are improved by an inexpensive and simple configuration.

Since the porous layer 51 and the non-porous layer 52 are alternately disposed in the radial direction, both of improvement in insulation properties and an increase in strength of the insulating film 5 can be achieved. In addition, since the non-porous layer 52 is disposed between the porous layers 51 in the radial direction, formation of large cavities obtained by coupling the porous 54 in the radial direction can be suppressed. Accordingly, independence of the porous 54 in the porous layer 51 can be guaranteed by the non-porous layer 52. Accordingly, it is possible to provide the electric wire 10 in which insulation properties of the insulating film 5 are improved by an inexpensive and simple configuration.

In addition, since a thickness of one layer of the porous layer 51 is configured to be 20 μm or less, even if the porous 54 are coupled to each other in the porous layer 51, a size of the cavity is 20 μm or less.

Here, the reason for setting an upper limit value of the thickness of the one layer of the porous layer 51 to 20 μm will be described.

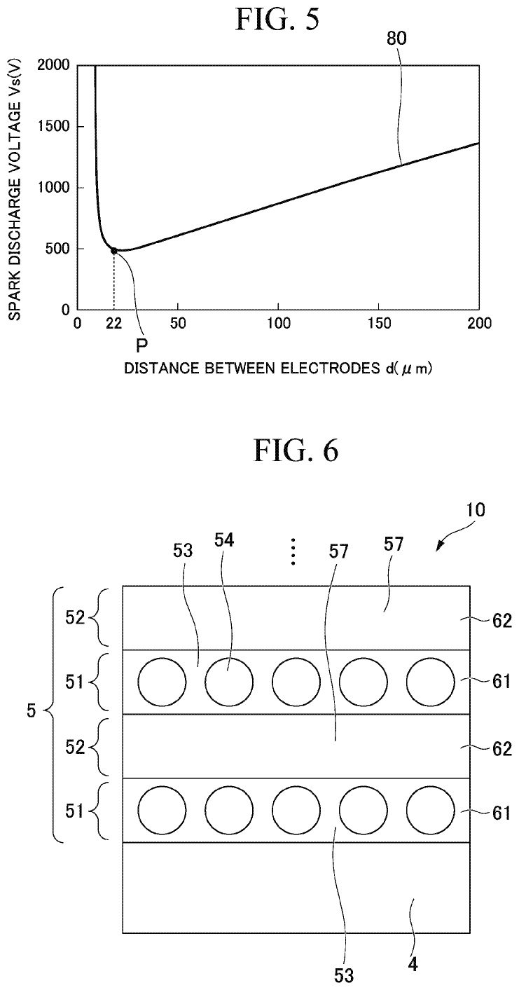

FIG. 5 is a graph showing a discharge starting voltage when a voltage is applied between parallel flat plates (electrodes) under an atmospheric environment, a so-called Paschen curve 80. The graph in FIG. 5 shows ease (difficulty) in occurrence of discharge due to an inter-electrode distance when a horizontal axis represents an inter-electrode distance and a vertical axis represents a spark discharge voltage. As shown in FIG. 5, under the atmospheric environment, a voltage at which discharge between the electrodes starts to occur becomes a minimum value P when the inter-electrode distance is about 22 μm. When the inter-electrode distance is 22 μm or less, an initial electron present (in a gap) between the electrodes cannot be sufficiently accelerated because a distance at which the initial electron is short, and discharge cannot easily occur. Meanwhile, when the inter-electrode distance is 22 μm or more, while the discharge cannot easily occur because the electric field strength between the electrodes is insufficient and the initial electron cannot be accelerated, the discharge may occur due to an increase in voltage between the electrodes. Accordingly, the discharge is the least likely to occur in a range in which the inter-electrode distance is 20 μm or less.

According to the electric wire 10 of the embodiment, the thickness of the one layer of the porous layer 51 is 20 μm or less, and the side of the gap is 20 μm or less. Accordingly, even when the cavity is formed, the size of the cavity can be set to a range in which the discharge cannot easily occur. Accordingly, it is possible to provide the electric wire 10 having the insulating film 5 in which occurrence of partial discharge in the insulating film 5 is inhibited and insulation properties are excellent.

In addition, since the insulation properties are secured even when the porous 54 are coupled to form the cavity, there is no need to cover each of the porous 54 with the outer shell member. Accordingly, there is no need to provide the outer shell member, and material costs or manufacturing costs can be reduced.

In addition, since the non-porous layer 52 having a smooth surface in which the porous 54 that can become an origin of cracks is not formed is disposed as the outermost layer of the insulating film 5, occurrence of the cracks with respect to the bending can be suppressed. Further, even when a density of the porous 54 in the porous layer 51 is increased, since occurrence of cracks in the outermost layer of the insulating film 5 can be suppressed, flexibility of the insulating film 5 can be improved while securing excellent insulation properties.

According to the stator 1 of the embodiment, it is possible to provide an inexpensive and high performance stator 1 since the electric wire 10 in which insulation properties of the insulating film 5 are improved by an inexpensive and simple configuration as described is provided.

### Second Embodiment

Next, a second embodiment according to the present invention will be described. FIG. 6 is a cross-sectional view of the electric wire 10 according to the second embodiment, taken along line in FIG. 2. The second embodiment is distinguished from the above-mentioned embodiment in that the porous layer 51 has one porous layer forming film 61. In the following description, components the same as those in the above-mentioned first embodiment are designated by the same reference numerals and appropriate description thereof will be omitted.

In the embodiment, the porous layer 51 has one porous layer forming film 61. The non-porous layer 52 has one non-porous layer forming film 62. The porous layer 51 and the non-porous layer 52 are alternately disposed in the radial direction of the conductor 4. In other words, the porous layer forming film 61 and the non-porous layer forming film 62 are alternately disposed one at a time in the radial direction of the conductor 4.

According to the embodiment, since the porous layers 51 are subdivided by the non-porous layer 52, it is easier to make the porous 54 of the porous layer 51 independent. In addition, since the thickness of one layer of the porous layer 51 is reduced in comparison with the case in which the porous layer 51 has the plurality of porous layer forming films 61, even when the porous 54 are coupled, a size of the cavity in the radial direction can be particularly minimized. Accordingly, according to the embodiment, it is possible to provide the insulating film 5 in which occurrence of partial discharge is suppressed due to formation of the cavity and presence of the cavity.

Further, the technical scope of the present invention is not limited to the above-mentioned embodiments and various modifications may be made without departing from the scope of the present invention.

For example, while the configuration in which the non-porous layer 52 is disposed on the outermost surface of the insulating film 5 has been described in the above-mentioned embodiment, there is no limitation thereto. That is, an initial layer (a layer in contact with the conductor 4) and a final layer (a layer disposed on the outermost surface of the electric wire 10) may be any one of the porous layer 51 and the non-porous layer 52.

In addition, a cross-sectional shape of the conductor 4 and the insulating film 5 may be, for example, a round shape or the like.

A material of the insulating materials 53 and 57 may be an insulating resin in addition to polyimide.

While the number of layers of the porous layer forming films 61 included in the single porous layer 51 one or a plurality of layers, the number of layers is preferable to be five or less. Further, insulation properties of the insulating film 5 are improved as a volume of the porous layer 51 occupied with respect to the entire volume of the insulating film 5 is increased, and bending strength of the insulating film 5 is increased as the volume occupied by the non-porous layer 52 is increased.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An electric wire comprising:
a conductor; and
an insulating film that is configured to cover the conductor and that includes a porous layer having porous in an insulating material, and a non-porous layer formed with the insulating material while having no porous therein.

2. The electric wire according to claim 1, wherein the insulating film is formed of a plurality of three or more layers by alternately disposing the porous layers and the non-porous layers in a radial direction of the conductor.

3. The electric wire according to claim 1, wherein a thickness of the single porous layer is 20 μm or less.

4. The electric wire according to claim 2, wherein a thickness of the single porous layer is 20 μm or less.

5. A stator comprising the electric wire according to claim 1.
